(19) United States
(12) Patent Application Publication
(10) Pub. No.: US 2019/0325478 A1
(43) Pub. Date: Oct. 24, 2019

(54) MOTION SENSOR-BASED FRAUD PREVENTION

(71) Applicant: Lumini Corporation, San Diego, CA (US)

(72) Inventor: Nils Forsblom, San Diego, CA (US)

(21) Appl. No.: 16/388,862

(22) Filed: Apr. 18, 2019

Related U.S. Application Data
(60) Provisional application No. 62/659,246, filed on Apr. 18, 2018.

(51) Int. Cl. G06Q 30/02; G06F 3/0485; G06F 3/0488; G06F 3/0481; H04M 1/725

(52) U.S. Cl. CPC G06Q 30/0248; G06Q 30/0267; G06F 3/0485; H04W 12/12; G06F 3/0481; H04M 1/72569; G06F 3/04883

(57) ABSTRACT

The prevention of fraudulent registrations of interactions with content begins with receiving the content on a client computer system for rendering thereon. The content includes a fraud detection client executed by the client computer system in conjunction with the rendering of the content. An input corresponding to an interaction with the content is received, followed by capturing motion sensor data from the client computer system with the fraud detection client contemporaneously with receiving the input corresponding to the interaction with the content. The captured motion sensor data is transmitted to a fraud detection server. The legitimacy of the interaction with the content is validated on the fraud detection server. This validation is based upon an evaluation of the captured motion sensor data in comparison to a set of one or more sensor data conditions.

### CROSS-REFERENCE TO RELATED APPLICATIONS

This application relates to and claims the benefit of U.S. Provisional Application No. 62/659,246 filed Apr. 18, 2018 and entitled “MOTION-SENSOR BASED ADVERTISEMENT IMPRESSION FRAUD PREVENTION SYSTEM,” the entire disclosure of which is wholly incorporated by reference herein.

### STATEMENT RE: FEDERALLY SPONSORED RESEARCH/DEVELOPMENT

Not Applicable

### BACKGROUND

### 1. Technical Field

The present disclosure relates generally to mobile devices and onboard micro-electro-mechanical sensors thereof, and more particularly, to motion sensor-based fraud prevention.

### 2. Related Art

Mobile devices such as smartphones and tablets fulfill a variety of roles. Although such devices can take on different form factors with varying dimensions, there are several commonalities between devices that share this designation. These include a general-purpose data processor that executes pre-programmed instructions, along with wireless communication modules by which data is transmitted and received. The processor further cooperates with multiple input/output devices, including combination touch input display screens, audio components such as speakers, microphones, and related integrated circuits, GPS modules, and physical buttons/input modalities. More recent devices also include accelerometers, gyroscopes, and compasses/magnetometers that can sense motion and direction. For portability purposes, these components are powered by an on-board battery. Several distance and speed-dependent communication protocols may be implemented, including longer range cellular network modalities such as GSM (Global System for Mobile communications), CDMA (Code Division Multiple Access), and so forth, high speed local area networking modalities such as WiFi, and short-range device-to-device data communication modalities such as Bluetooth.

Management of these hardware components is performed by a mobile operating system, also referenced in the art as a mobile platform. Currently, popular mobile platforms include Android from Google, Inc., iOS from Apple, Inc., and Windows Phone, from Microsoft, Inc. The mobile operating system provides several fundamental software modules and a common input/output interface that can be used by third party applications via application programming interfaces.

A common use for mobile devices is the consumption of media content, whether that be in the form of the written word, e.g., news or other informational articles, blog posts, etc., audio, e.g., music, audiobooks, podcasts, etc., or video, e.g., movies, short clips, shows, etc. Although the costs associated with the mobile device and base connectivity services are typically paid for by the user, conventional online media business practices involve providing such content free of charge or at minimal cost. In order to offset the costs relating to the technical operational aspects such as server maintenance, network bandwidth, and the like, as well as the costs relating to the production of the content itself including payment to authors, editors, and other production personnel, these content providers may rely on advertising revenue. This model has been extended to software applications or apps that provide functionality beyond that which is provided by the mobile operating system, such as productivity features and gaming.

Advertising on a mobile device can be presented in various ways. One of the most common is the banner ad, which is a graphic designed by the advertiser and placed in a prominent location within a content page. Several technical solutions that achieve this functionality are known in the art, such as embedding the banner advertisement in-line with the content but laid out on the top, side, or bottom ends of the page, displaying the banner advertisement in a separate static frame that does not move when scrolling, and so forth. Besides static graphics, animations, sound, video and different interactive elements can be also be integrated into the banner ad. Selecting the banner advertisement typically directs the user to the advertiser's website, where additional information and an opportunity to purchase the advertised product can be provided. The content provider may have a contractual arrangement with an advertising network, which receives the advertising copy, specifications as to the target audience/advertisement campaign, and payment. Based on the engagement of the audience of the content provider with the advertisement, which is recorded by the advertising network, portions of the collected payment, in turn, may be paid to the content provider.

There are a variety of ways in which an illegitimate content provider that presents the advertisements and collect the payment without actual audience engagement with those advertisements. Impression fraud is where a fraudulent content provider stacks several advertisements together but making only one visible, all while charging for each of the advertisements. The content provider may also place the advertisement in an obscure location within a webpage where it may not be visible, even if it is on the page. Click fraud or attribution fraud is where fake users or bots generate transaction identifiers that are counted as a click or an engagement. Such fraud is understood to cost billions of dollars annually, and fraudsters are able to earn substantial sums of money serving advertisements that are never seen by anyone.

Accordingly, there is a need in the art for detecting and preventing fraud in connection with online advertisements.

### BRIEF SUMMARY

The present disclosure contemplates the prevention of online advertisement fraud. More particularly, according to one embodiment, there may be a method for preventing fraudulent registrations of interactions with content. The method may include receiving the content on a client computer system for rendering thereon. The content may include a fraud detection client executed by the client computer system in conjunction with the rendering of the content. There may also be a step of receiving an input corresponding to an interaction with the content. The method may also include a step of capturing motion sensor data from the client computer system with the fraud detection client contemporaneously with receiving the input corresponding to the interaction with the content. Then, there may be a step of transmitting the captured motion sensor data to a fraud detection server. The method may also include validating, on the fraud detection server, a legitimacy of the interaction with the content through the client computer system. This validation may be based upon a first evaluation of the captured motion sensor data in comparison to a first set of one or more sensor data conditions. The method may also include transmitting, to a content server, a validation response associated with a registration of the interaction with the content.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating an exemplary networked computing environment in which embodiments of the present disclosure may be implemented;

FIG. 2 is a block diagram of the components of a mobile device that may be utilized in various embodiments;

FIG. 3 is a flowchart depicting on embodiment of a method for preventing fraudulent registrations of interactions with content.

### DETAILED DESCRIPTION

The detailed description set forth below in connection with the appended drawings is intended as a description of the several presently contemplated embodiments of motion sensor-based fraud prevention and is not intended to represent the only form in which such embodiments may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

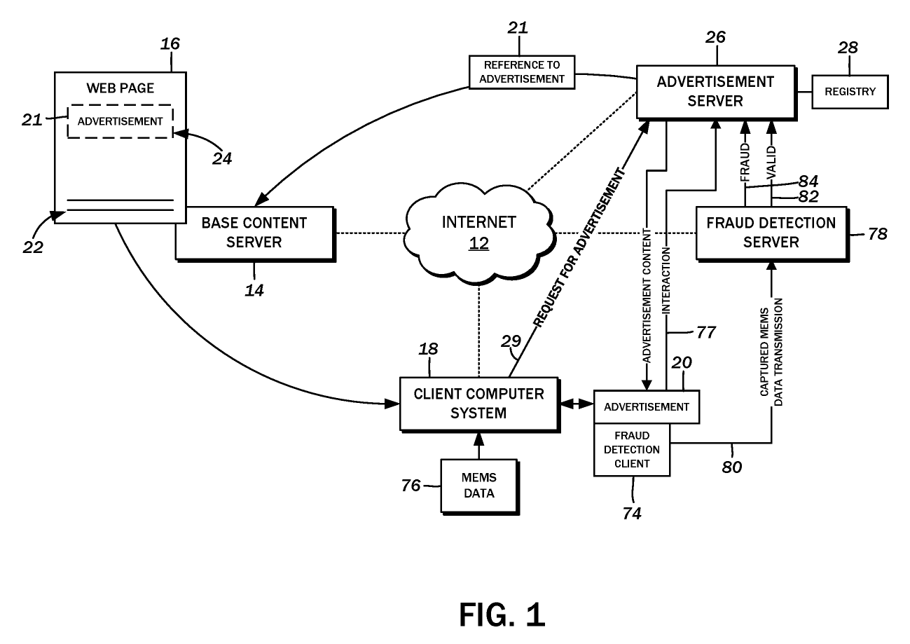

Referring now to FIG. 1, one embodiment of the present disclosure is directed to fraud prevention, particularly in the context of online advertisements. Although the technical details of executing the fraud may vary, at a fundamental level, fraud occurs when one party is compensated by an advertiser for running advertisements when the target audience has been fabricated or otherwise falsified. As advertisements delivered online may be tracked on a more granular basis compared to advertisements run on traditional media (where the cost is dependent on broad circulation numbers and the like), different engagement levels with the viewing audience can be compensated accordingly. For instance, an impression, which is when the underlying base content plus and advertisement is presented on a client computer system, may have one price, while a click-through, which is when particular user engages further and clicks or otherwise activates a link for further information, etc. from the advertisement, may have another, higher, price. Some advertisements may be to apps or other user-downloadable software, and a different level of compensation may be paid to the extent the user installs that software. A report of a completed installation of the app may be provided with a postback event. By falsifying impressions, click-throughs, app installations/postback events, and other audience engagement tracking modalities, a deceptive content publisher may be paid for that which did not occur.

FIG. 1 depicts the basic components of an online advertisement ecosystem 10 that are interconnected over the Internet 12. There is a base content server 14 which publishes one or more web pages 16 that are accessible by a client computer system 18 over the Internet 12. The specifics of the base content server 14 of serving the web pages 16 is presented by way of example only, and the term content is referred to in the general sense of any information that may be stored on the base content server 14 and rendered on the client computer system 18. This may include text data, images, audio, video, or any other type or subtype of content.

In an implementation where the base content server 14 is used to serve the web pages 16, it is understood to be a hypertext transfer protocol (HTTP) server, though it may be any other type of server that responds to client requests with data corresponding to such request. The base content server 14 may be a computer system including a general-purpose data processor with memory and data storage components, along with networking components to connect to the Internet 12. The data processor executes pre-programmed, machine-readable instructions that corresponds to the various functions performed by the HTTP server.

The web page 16 may include a display advertisement 20 that is presented together with web page content 22 when rendered on the client computer system 18. In this regard, the client computer system 18 is understood to have installed thereon a web browser application, the detailed features of which will be omitted. The display advertisement 20 may be a banner, a frame ad, a pop-up or pop-under, floating ad, expanding ad, a trick banner, and so on, and incorporate various advertising messages such as text, graphics, audio, animations, video, and the like.

The web page 16 defines a specific location 24 therein that is designated for the advertisement 20, which includes a reference 21 or a call to a remote advertisement server 26 indicating that an advertisement 20 may be placed there. Such reference may include additional parameters such as keywords, expected reader profiles and the like that assist the advertisement server 26 with serving relevant advertisements with which the viewer of the particular web page 16 most likely will engage. The specific content of the advertisement 20 is understood to be transmitted from the advertisement server 26 to the client computer system 18 when the web page 16 is rendered on the client computer system 18, and prior to which the base content server 14 transmits the web page 16 to the client computer system 18. More particularly, a request 29 may be made from the client computer system 18 at the time of rendering the web page 16, with such request being generated when attempting to resolve the reference 21 to the advertisement 20.

Upon being rendered on the client computer system 18 a user thereof may interact with the advertisement 20 in various ways. For instance, the a link within the advertisement 20 may be activated to load a different webpage associated with the advertiser. There may be interactive elements within the advertisement 20 that the user may manipulate to yield a result. The advertisement 20 may prompt a user to install one or more apps, and upon successful completion thereof, the client computer system 18 may generate a postback event. Those having ordinary skill in the art will recognize the myriad of different types of interaction that are possible with the advertisement 20. These interactions are reported to the advertisement server 26, since the data and any executable functions of the advertisement 20 originate therefrom. A record of these interactions are stored in a registry 28, with the data thereof being used to pay the content provider an agreed-upon fee for placing the advertisement 20. The mere loading/presentation of the advertisement 20 on the client computer system 18, that is, an impression, may likewise be recorded in the registry 28.

In considering the user interactions with the advertisement 20, some parts of the present disclosure refer to an interaction with content, and more specifically, preventing fraudulent registrations of interactions with content. In this context, content is understood to encompass the advertisement 20 as well as any other forms of data, applications, media, and so forth with which a user may interact to generate revenue for a content provider. Thus, the advertisement server 26 may also be referred to as a content server, which is understood to be generally independent of the base content server 14. The foregoing online advertisement ecosystem 10 is understood to be a substantially simplified version depicting just the basic components thereof that will facilitate the follow discussion of the embodiments of a fraud prevention system. The online advertisement ecosystem 10 may thus include additional components not depicted in FIG. 1, or take alternative forms. Those having ordinary skill in the art will be readily able to adapt the present disclosure of the fraud prevention system to other online advertisement systems.

Again, the embodiments of the present disclosure contemplate the prevention of fraud with respect to interactions with the advertisement 20, and in particular, the falsification of such interactions. The existing components of the client computer system 18 may be utilized to determine whether or not a given interaction is legitimate, by analyzing motion data and identifying “natural behaviors” that are understood to be contemporaneous with the purported interaction.

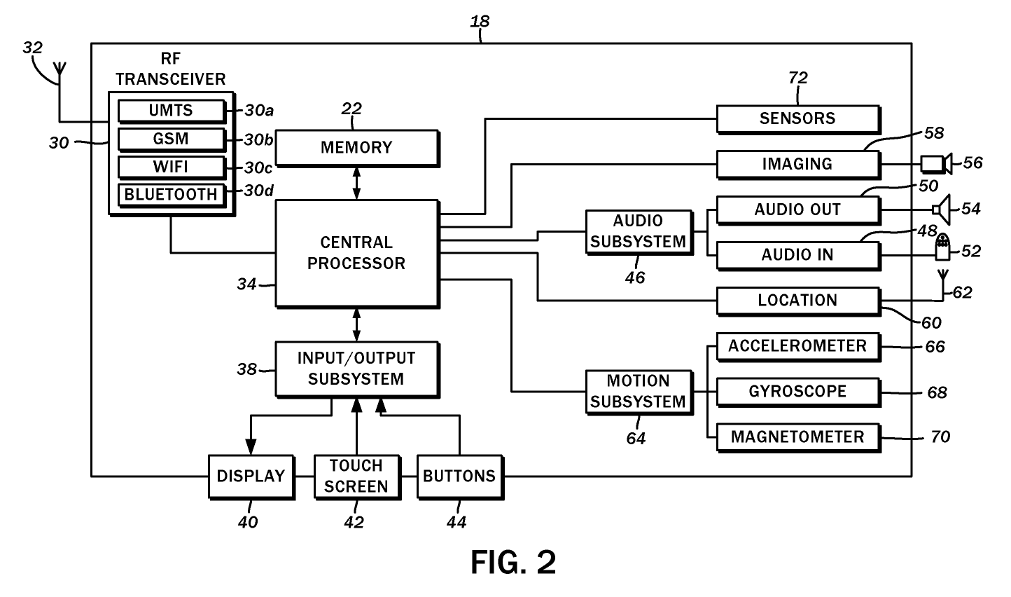

FIG. 2 illustrates one exemplary client computer system 18, which may be a mobile device such as a smartphone. Thus, there may be a radio frequency (RF) transceiver 30 that transmits and receives signals via an antenna 32. Conventional devices are capable of handling multiple wireless communications modes simultaneously. These include several digital phone modalities such as UMTS (Universal Mobile Telecommunications System), 4G LTE (Long Term Evolution), and the like. For example, the RF transceiver 30 includes a UMTS module 30a. To the extent that coverage of such more advanced services may be limited, it may be possible to drop down to a different but related modality such as EDGE (Enhanced Data rates for GSM Evolution) or GSM (Global System for Mobile communications), with specific modules therefor also being incorporated in the RF transceiver 30, for example, GSM module 30b. Aside from multiple digital phone technologies, the RF transceiver 30 may implement other wireless communications modalities such as WiFi for local area networking and accessing the Internet by way of local area networks, and Bluetooth for linking peripheral devices such as headsets. Accordingly, the RF transceiver may include a WiFi module 30c and a Bluetooth module 30d. The enumeration of various wireless networking modules is not intended to be limiting, and others may be included without departing from the scope of the present disclosure.

The client computer system 18/mobile device is understood to implement a wide range of functionality through different software applications, which are colloquially known as “apps” in the mobile computing device context. The software applications are comprised of pre-programmed instructions that are executed by a central processor 34 and that may be stored on a memory 36. There may be other embodiments, however, utilizing self-evolving instructions such as with Artificial Intelligence (AI) systems. The results of these executed instructions may be output for viewing by a user, and the sequence/parameters of those instructions may be modified via inputs from the user. To this end, the central processor 34 interfaces with an input/output subsystem 38 that manages the output functionality of a display 40 and the input functionality of a touch screen 42 and one or more buttons 44. The software instructions comprising apps may be pre-stored locally on the client computer system 18/mobile device, though web-based applications that are downloaded and executed concurrently are also contemplated.

In a conventional smartphone device, the user primarily interacts with a graphical user interface that is generated on the display 40 and includes various user interface elements that can be activated based on haptic inputs received on the touch screen 42 at positions corresponding to the underlying displayed interface element. One of the buttons 44 may serve a general purpose escape function, while another may serve to power up or power down the device. Additionally, there may be other buttons and switches for controlling volume, limiting haptic entry, and so forth. Those having ordinary skill in the art will recognize other possible input/output devices that could be integrated into the client computer system 18/mobile device, and the purposes such devices would serve. Other smartphone devices may include keyboards (not shown) and other mechanical input devices, and the presently disclosed interaction methods with the graphical user interface detailed more fully below are understood to be applicable to such alternative input modalities.

The client computer system 18/mobile device includes several other peripheral devices. One of the more basic is an audio subsystem 46 with an audio input 48 and an audio output 50 that allows the user to conduct voice telephone calls. The audio input 48 is connected to a microphone 52 that converts sound to electrical signals, and may include amplifier and ADC (analog to digital converter) circuitry that transforms the continuous analog electrical signals to digital data. Furthermore, the audio output 50 is connected to a loudspeaker 54 that converts electrical signals to air pressure waves that result in sound, and may likewise include amplifier and DAC (digital to analog converter) circuitry that transforms the digital sound data to a continuous analog electrical signal that drives the loudspeaker 54. Furthermore, it is possible to capture still images and video via a camera 56 that is managed by an imaging module 58. Again, the camera 56 is referred to generally, and is not intended to be limited to conventional photo sensors. Other types of sensors such as LIDAR, radar, thermal, and so on may also be integrated.

Due to its inherent mobility, users can access information and interact with mobile device practically anywhere. Additional context in this regard is discernible from inputs pertaining to location, movement, and physical and geographical orientation, which further enhance the user experience. Accordingly, the mobile computing device includes a location module 60, which may be a Global Positioning System (GPS) receiver that is connected to a separate antenna 62 and generates coordinates data of the current location as extrapolated from signals received from the network of GPS satellites. Motions imparted upon the client computer system 18/mobile device as well as the physical and geographical orientation of the same, may be captured as data with a motion subsystem 64, in particular, with an accelerometer 66, a gyroscope 68, and/or a compass/magnetometer 70, respectively. Although in some embodiments the accelerometer 66, the gyroscope 68, and the compass 70 directly communicate with the central processor 34, more recent variations of the mobile device utilize the motion subsystem 64 that is embodied as a separate co-processor to which the acceleration and orientation processing is offloaded for greater efficiency and reduced electrical power consumption. One exemplary embodiment of the client computer system 18/mobile device is the Apple iPhone with the M7 motion co-processor.

The components of the motion subsystem 64, including the accelerometer 66, the gyroscope 68, and the magnetometer 70, while shown as integrated into the client computer system 18/mobile device may be incorporated into a separate, external device. This external device may be wearable by the user and communicatively linked to the client computer system 18/mobile device over the aforementioned data link modalities. The same physical interactions contemplated with the mobile device to invoke various functions as discussed in further detail below may be possible with such external wearable device.

There are other sensors 72 that can be utilized in the client computer system 18/mobile device for different purposes. For example, one of the other sensors 72 may be a proximity sensor to detect the presence or absence of the user to invoke certain functions, while another may be a light sensor that adjusts the brightness of the display 40 according to ambient light conditions. Those having ordinary skill in the art will recognize that other sensors 72 beyond those considered herein are also possible.

Referring back to the block diagram of FIG. 1, the advertisement 20 may include a fraud detection client 74 implemented as browser-executable code. Alternatively, in instances where the advertisement 20 accompanies natively-executed code, the fraud detection client 74 may be implemented with the same. The advertisement server 26 may send the fraud detection client 74 together with the advertisement 20 when it is served to the client computer system 18, and so the base content server 14 may not be aware of the existence thereof. The most likely source of any impression or click-through fraud is understood to be the content provider, and so eliminating the possibility of interference therefrom is likely to be the most efficacious. However, it is also possible for the base content server 14 to report to the advertisement server 26 that the web page 16 and/or the advertisement 20 has been served to the client computer system 18 and at least provisionally registered as such with the advertisement server 26.

Generally, the fraud detection client 74 may be initialized on the client computer system 18 before the advertisement 20 itself is served, with the initial call to the advertisement server 26 from the reference to the advertisement as incorporated into the rendered web page 16 being operative to retrieve and begin execution of the fraud detection client 74. Retrieval and execution of the fraud detection client 74 may also take place before the web page 16 is served. Again, either a web application programming interface (API) or a native API may trigger the initialization of the fraud detection client 74.

Once initialized, the fraud detection client 74 may initiate the capture of micro-electro-mechanical sensors (MEMS) data 76 from the onboard accelerometer 66, the gyroscope 68, and/or the compass/magnetometer 70. In accordance with various embodiments, an interaction 77 with a graphical element presented on the client computer system 18/mobile device is contemplated to have a corresponding seismic signature that accompanies the input. More particularly, the haptic input to the touch screen 42 is understood to impart a motion upon the mobile device, which is detected by the onboard sensors that in turn generates the MEMS data 76.

The captured data is provided to a fraud detection server 78 in a data transmission 80. The fraud detection server 78 then compares the captures MEMS data 76 with known data signatures corresponding to the haptic input. By way of example, a tap on the touch screen 42 is understood to have a particular signature or sensor data condition, while a swipe from a first position to a second position on the touch screen 42 may have another signature or sensor data condition. Still further, a scroll or a flick may have yet another different signature or sensor data condition. Beyond these types of motions and corresponding sensor data signatures, rotations and other movements imparted to the client computer system 18/mobile device are also possible.

When the captured MEMS data 76 matches the expected signature for the input, the authenticity of that interaction with the advertisement 20 is validated, and duly recorded in the registry 28 by the advertisement server 26. The fraud detection server 78 may communicate a valid flag transmission 82 to the advertisement server 26 if the associated interaction has been evaluated as legitimate.

If, on the other hand, there is no accompanying MEMS data 76 with the interaction 77, or the MEMS data 76 is analyzed by the fraud detection server 78 as having a different signature than expected, the interaction 77 is not recorded in the registry 28. The failed validation is reported by the fraud detection server 78 via a fraud flag transmission 84 to the advertisement server 26. These validations and fraud identifications may also be transmitted to a different server, or back to the fraud detection client 74. Additionally, such data may be relayed to a blockchain system or other like distributed database for future reference during payment.

Once an interaction 77 is received by the advertisement server 26, a window of time may be allotted for either the valid flag transmission 82 of the fraud flag transmission 84 to arrive. Thus, the interaction 77 should be substantially contemporaneous with the captured motion in order to be authenticated as valid. Other comparisons between the interaction 77 are possible, including the determining of whether the provided MEMS data 76 is more likely to be that of a bot impersonating or partially impersonating a human user.

In addition to the foregoing sensor-based fraud detection techniques, additional modalities for detecting fraud are possible utilizing any and all information that is available or discernible by the advertisement server 26 before it records in the registry 28 any purported interaction between a user and the advertisement 20. Machine-learned or artificial intelligence processes may be applied to captured data, and the advertisement 20 may be programmed with subtle variations in the time and/or interaction instructions. For example, if an interactive advertisement prompts the user to swipe horizontally, one instantiation of the advertisement 20 may prompt the user to swipe left, while in another instantiation, the user may be prompted to swipe right. In another example, if an interactive advertisement prompts the user to tilt the mobile device, this may be interchanged with a prompt to shake the mobile device, and so forth. Location data generally associated with a purported client Internet Protocol (IP) address may be compared to the actual location, and may be another factor to be evaluated to determine whether the purported interaction with the advertisement 20 is fraudulent. Furthermore, one or more pixel values as shown on the display 40 may be compared with expected values of the advertisement content, so that advertisement stacking, where multiple advertisements 20 are layered on top of each other with only one being actually presented to the user, can be curtailed. These data gathering and analysis functions may be performed by the fraud detection client 74.

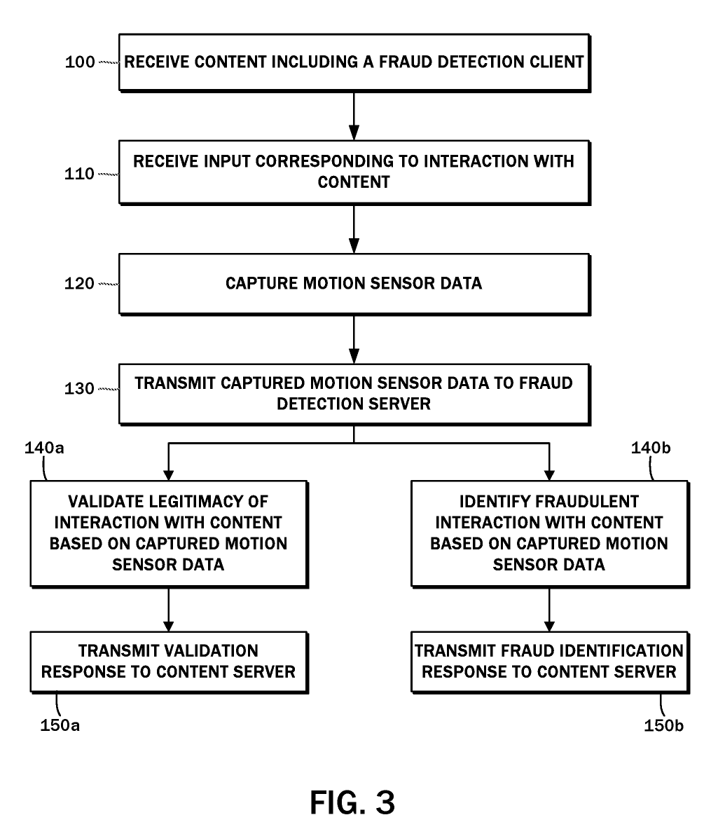

Referring now to the flowchart of FIG. 3, one embodiment of a method for preventing fraudulent registrations of interactions with content will be considered. The method begins with a step 100 of receiving the content, e.g., the advertisement 20 on the client computer system 18 for rendering thereon. As described above, the advertisement 20 includes the fraud detection client 74 that may be executed by the client computer system 18 in conjunction with rendering the advertisement 20 as well as other content, e.g. the web page 16.

As the user of the client computer system 18 interacts with the advertisement 20 as described above, the method proceeds with a step 110 of receiving an input corresponding to the interaction with the advertisement 20 or content. One example of this is the receiving the haptic input on the touch screen 42. Concurrently or contemporaneously, the motion sensor data is captured from the client computer system 18 in a step 120. This may be performed by the fraud detection client 74. Next, in a step 130, the captured motion sensor data may be transmitted to the fraud detection server 78.

The interaction may then be either validated or identified as fraudulent depending on the analysis of the captured motion sensor data. In a step 140a, the legitimacy of the interaction with the content is validated based on an evaluation of the captured motion sensor data 76 in comparison to sensor data conditions. As referenced herein, sensor data conditions is understood to be the aforementioned signatures or other profile that is known to be associated with a legitimate interaction, e.g., the haptic input of a tap having a corresponding motion data. Following this validation, there may be a step 150a of transmitting a validation response that is associated with a registration of the interaction with the content, that is, recording the interaction as valid in the registry 28 of the advertisement server 26 or other server for subsequent payment to the content provider that presented the advertisement 20.

There may be an alternative step 140b of identifying a fraudulent interaction with the content or advertisement 20 based upon another evaluation of the captured motion sensor data 76 to another set of conditions. These conditions may be the lack of any MEMS sensor data accompanying the interaction 77, or other like known conditions that are indicative of fraud. Thereafter, in a step 150b, a fraud identification response is transmitted to the advertisement server 26.

Based on the foregoing general description of the method, several exemplary use cases will be described. When there is a valid human interaction 77 with the advertisement 20, the user sees the web page 16 and the advertisement 20 thereon. The content is served, and the publisher (e.g., the base content server 14) registers the impression thereon. The various scrolls and taps are matched to the small motions as detected by the onboard motion sensors, and the impression is authenticated. The advertiser may then compare the fraud detection and publisher analytics to ensure that no improper interactions are being paid out.

As explained above, impression fraud occurs when bots or other automated systems are used to inflate the number of impressions. In such case, the bot is understood to retrieve the web page 16 from the base content server 14, and interacts with the advertisement 20 by programmatically inputting simulated data thereto in the form of clicks, taps, etc. As above, the publisher, or the base content server 14 registers each impression thereon. The lack of motion sensor registering data, or mismatching click or tap and motion data flags the interaction as potentially fraudulent with the fraud detection server 78. The advertiser, following a comparison of the fraud detection and the base content server 14, may reduce payment or take other corrective action in response thereto.

A valid attribution event for recording user installations of advertised apps may be recognized in accordance with the procedures described above. In general, the user accesses the web page 16 in question, and the content, including the advertisement 20, is served. Concurrently, the publisher or base content server 14 registers the impression thereon. The click, or motion data corresponding to the user interaction therewith is authenticated, and the fraud detection server 78 is alerted with the impression authentication. A transaction identifier may be generated in response, which may be used to attribute later downloads or installation of an advertised app.

A fraudulent attribution event, on the other hand, results in a failed validation due to a lack of a click or motion data that would otherwise be generated in the event of a valid user interaction. The aforementioned transaction identifier is not sent from the fraud detection server 78, so subsequent downloads or installation of an advertised app is not credited.

All of the data received and analyzed by the fraud detection server 78 may be aggregated, and a report or summary may be generated therefrom to identify fraudsters for quick termination of the advertising relationship. Over time, the presently contemplated fraud prevention system is envisioned to reduce chargeback rates, while rate disputes and manual review may be reduced because of the availability of actual (or at least closer to actual) advertisement engagement rates. Furthermore, overall improvements in returns on investment with online advertising are contemplated.

The particulars shown herein are by way of example and for purposes of illustrative discussion of the embodiments of motion sensor-based fraud prevention and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A method for preventing fraudulent registrations of interactions with content, the method comprising:
receiving the content on a client computer system for rendering thereon, the content including a fraud detection client executed by the client computer system in conjunction with the rendering of the content;
receiving an input corresponding to an interaction with the content;
capturing motion sensor data from the client computer system with the fraud detection client contemporaneously with receiving the input corresponding to the interaction with the content;
transmitting the captured motion sensor data to a fraud detection server;
validating, on the fraud detection server, a legitimacy of the interaction with the content through the client computer system based upon a first evaluation of the captured motion sensor data in comparison to a first set of one or more sensor data conditions; and
transmitting, to a content server, a validation response associated with a registration of the interaction with the content.

2. The method of claim 1, further comprising:
identifying, on the fraud detection server, a fraudulent interaction with the content through the client computer system based upon a second evaluation of the captured motion sensor data in comparison to a second set of one or more sensor data conditions.

3. The method of claim 2, further comprising:
transmitting, to the content server, a fraud identification response associated with an attempted registration of the interaction with the content.

4. The method of claim 1, wherein the client computer system is a mobile communications device.

5. The method of claim 1, wherein the interaction with the content is a haptic input to a touch display of the client computer system, the haptic input imparting a motion upon the client computer system captured by sensors on the client computer system.

6. The method of claim 5, wherein the first set of one or more sensor data conditions corresponds to the sensor data captured by the sensors from the motion imparted to the client computer system.

7. The method of claim 6, wherein the haptic input is a tap on the touch display.

8. The method of claim 6, wherein the haptic input is a swipe from a first location to a second location on the touch display.

9. The method of claim 6, wherein the haptic input is a scrolling flick on the touch display.

10. A method for preventing fraudulent registrations of interactions with content, the method comprising:
receiving, on a fraud detection server from a client computer system, motion sensor data captured in conjunction with a detected interaction with the content on the client computer system;
validating, on the fraud detection server, a legitimacy of the detected interaction with the content based upon an evaluation of the captured motion sensor data in comparison to one or more sensor data conditions; and
transmitting, to a content server, a validation response associated with a registration of the interaction with the content.

11. The method of claim 10, wherein the interaction with the content is a haptic input to a touch display of the client computer system, the haptic input imparting a motion upon the client computer system captured by sensors on the client computer system.

12. The method of claim 11, wherein the haptic input is a tap on the touch display.

13. The method of claim 11, wherein the haptic input is a swipe from a first location to a second location on the touch display.

14. The method of claim 11, wherein the haptic input is a scrolling flick on the touch display.

15. A method for preventing fraudulent registrations of interactions with content, the method comprising:
receiving, on a fraud detection server from a client computer system, motion sensor data captured in conjunction with a detected interaction with the content on the client computer system;
identifying, on the fraud detection server, a fraudulent interaction with the content through the client computer system based upon an evaluation of the captured motion sensor data in comparison to a second set of one or more sensor data conditions;
transmitting, to a content server, a fraud identification response associated with an attempted registration of the interaction with the content.

16. The method of claim 15, wherein the interaction with the content is a haptic input to a touch display of the client computer system, the haptic input imparting a motion upon the client computer system captured by sensors on the client computer system.

17. The method of claim 15, wherein the haptic input is a tap on the touch display.

18. The method of claim 15, wherein the haptic input is a swipe from a first location to a second location on the touch display.

19. The method of claim 15, wherein the haptic input is a scrolling flick on the touch display.
